(19) United States
(12) Patent Application Publication
(10) Pub. No.: US 2006/0232572 A1
(43) Pub. Date: Oct. 19, 2006

(54) Method and circuit arrangement for driving a display as well as chip card with display

(76) Inventor: Karl-Ragmar Riemschneider, (US)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/490,363

(22) PCT Filed: Sep. 17, 2002
(86) PCT No.: PCT/IB02/03867

§ 371 Date: Mar. 22, 2004

(30) Foreign Application Priority Data
Sep. 22, 2001 (DE) 101 46 804.0

(51) Int. Cl. G09G 5/00

(52) U.S. Cl. 345/204

(57) ABSTRACT

To provide a method and circuit arrangement for driving a display, in particular the display on a chip card, by means of which information optionally comprising a plurality of display images may be displayed simply and efficiently, provision is made that (a) in write mode, information to be displayed on the display which comprises at least one item of information content (display image) to be presented on the display is stored in a drive circuit associated solely with the display; (b) the ordering relationships also selectable in write mode are stored which are assigned explicitly to each of the items of information content and which determine the sequence of information contents in the event of display; (c) in read mode, the information to be displayed and comprising at least one item of information content is called up from the drive circuit and displayed on the display, wherein (d) the stored and explicitly assigned ordering relationships are taken into account with regard to the call and thus the display sequence.

The invention relates to a method and circuit arrangement for driving a display, in particular a display on a chip card, as well as to a chip card with display.

The use of a display in many technical applications is known. In the context of the invention, display is understood to mean a display device which is suitable for presenting information. The information itself consists of at least one item of information content (display image) presented on the display. Such information-presenting displays are known to be connected with a master unit (controller, processor) comprising a drive circuit for the display. The master unit supplies the information to be presented on the display. Depending on the structure of the display, drive signals for the display are provided by the master unit. Thus, for example, voltages and currents are made available which are suited to driving individual segments of the display in such a way that symbols, characters or the like may be presented on the display.

If the presentation of a display image is insufficient for a particular application, subdivision of the information contents into a plurality of display images is necessary, which are presented in succession on the display. To manage such information contents requiring a plurality of display images, it is known to provide the master unit, which assumes responsibility for driving the display, with appropriate software. A disadvantage thereof is that, in particular in the case of autonomously operating technical devices, e.g. chip cards, a voltage supply must be made available to the master unit for processing information contents to be presented and driving a display presenting the information. Since the master unit has a relatively large power demand, a voltage source of appropriate size is necessary.

A chip card provided with a display is known from DE 196 31 557 A1. A drive circuit separated logically and functionally from the chip card processor is in this case associated with the display. The display and drive circuit of the display have their own voltage supply in the form of a solar cell.

A chip card with display is known from FR 2 680 260 A1 in which information contents are stored in a stack memory. The sequence in which information is read out is thus determined by the sequence in which it is written, i.e. implicitly.

It is an object of the invention to provide a method and circuit arrangement for driving a display, in particular the display on a chip card, by means of which information optionally comprising a plurality of display images may be displayed simply and efficiently.

This object is achieved according to the invention by a method having the features mentioned in claim 1. Because

(a) in write mode, information to be displayed on the display which comprises at least one item of information content (display image) to be presented on the display is stored in a drive circuit associated solely with the display;

(b) also in write mode, selectable ordering relationships are stored which are assigned explicitly to each of the items of information content and which determine the sequence of information contents in the event of display;

(c) in read mode, the information to be displayed and comprising at least one item of information content is called up from the drive circuit and displayed on the display, wherein

(d) the stored and explicitly assigned ordering relationships are taken into account with regard to the call and thus the display sequence,

it is advantageously possible to store the information to be displayed in such a way in write mode that at least one, in the simplest case precisely one, item of successor information content is predetermined for each item of information content. This successor information content is stored as an assigned reference by the assigned, co-stored explicit ordering relationships. In this way, singly concatenated lists may be built up, in which the call sequence in read mode is independent of the physical sequence in the memory. Thus, a reference (ordering relationship) is assigned to each item of information content (display image), which reference refers to the next item of information content to be displayed, this alone resulting in the display sequence on the display.

The object is further achieved according to the invention by a circuit arrangement having the features mentioned in claim 13. Because a drive circuit associated solely with the display is provided, which may be switched into write mode and read mode, wherein the drive circuit may be activated for read mode independently of a control circuit activating write mode and providing information contents to be displayed, the drive circuit comprises a non-volatile memory, wherein a first circuit unit is provided which serves in separate entry of information to be displayed, which information comprises at least one item of information content to be presented on the display, in that information contents corresponding to the information to be displayed and explicit organization relationships assigned thereto may be stored separately, and a second circuit unit is provided which serves in reading out the information to be displayed and the assigned organization relationships, wherein the second circuit unit may be activated via a switching means, a circuit arrangement may advantageously be provided, which may be conformed simply and flexibly to various items of information to be displayed, wherein the power demand may be kept low in particular due to the simple structure of the circuit.

Preferred developments of the invention are revealed by the features mentioned in the subclaims.

Altogether, display functions may be independently performed without an active master unit (controller, processor) due to the configurations according to the invention of the method and/or the circuit arrangement for driving a display. By using structuring by means of the explicit ordering relationships, a small number of internal switching operations are sufficient in the drive circuit assigned to the display, such that, despite the possibility of being able to display a plurality of items of information content (display images), the sequence of which may be organized to suit the application, wherein only the circuit component of the drive circuit which organizes the read mode is active, the power demand is extremely small.

Finally, the method and circuit arrangement may assist flexibly in various applications, i.e. for example by being capable of varying the scope and organization of the sequence of information to be displayed or adding information contents quickly to the information to be displayed or quickly replacing, changing or removing said information.

Connection of the drive circuit of the display to the master unit (controller, processor), in particular for reception of the information to be displayed in write mode, may be simply achieved.

In a particularly preferred development of the invention, provision is made for the method and the circuit arrangement for driving a display to be implemented on a chip card comprising a display (cash card). Due to the simple structure of the circuit arrangement and the simple implementation of the method, the requirements which have to be met by a chip card with display in a card terminal, in a neutral rest state and in a user action independent of the card terminal may be fulfilled to the best possible degree.

In a card terminal, the master unit (controller, processor) of the chip card generally performs extensive, complicated operations, e.g. in order to run communications protocols or to calculate encryption algorithms. In this state, the fundamentals of the information of which the user wishes to take note on the display are generated or changed considerably. In particular, this information may relate to numerical values of credits or debits or time details in the case of electronic time stamping processes in the card terminal.

In the neutral rest state, which constitutes the majority of the life of a chip card, no activities take place. In this state, the chip card is merely carried around by the user for later use, upon which it is woken out of its rest state into one of the active states. On the other hand, after termination, to be defined, of an activity (as a rule after a particular interval or after removal from the card terminal), the chip card may automatically itself adopt the neutral rest state.

In the event of a user action without a card terminal, which is effected by means of the chip card display, the user enters directly into communication with the chip card. The circuit arrangement according to the invention and the method according to the invention for driving a display allow these requirements to be fulfilled, in that the drive circuit for the display is so designed that it comprises mutually independently operating circuit units which may mutually independently organize write mode and read mode. Write mode and read mode operate at different times with the respectively associated circuit units and communicate with a common memory area of the drive circuit.

In the write mode provided according to the invention, which is assumed in the chip card terminal in particular in conjunction with a transaction, authentication or the like, the explicit ordering relationships and the information contents of a plurality of display images are stored. Depending on the design and layout of the chip card, this storage may be effected in contacting or contactless manner. The written information contents and ordering relationships are saved in non-volatile manner in a memory of the display drive circuit, i.e. independently of operation in the chip card terminal. The memory is preferably an EEPROM memory or, according to another preferred development of the invention, a RAM memory. In particular, the RAM memory uses CMOS technology, since this requires extremely low current input. The required operating voltage may be supplied by an internal, simply structured power source. Such non-volatile memories are in a position to store the information contents of the display images and the ordering relationships at least for a period corresponding to the normal service life of the chip cards.

In a preferred development of the invention, provision is made for the memory to be organized logically in the form of two tables, wherein a first table is used for information contents of the display images. The data of each item of information content of each display image are stored as entries in the first table (hereinafter designated record table). In a second table, the information content display sequence is organized and the assigned explicit ordering relationships are stored. In the simplest case, this is effected in that, in the second table (hereinafter designated reference table), the table index of the next item of information content (display image) to be displayed is entered for each entry. The entry in this reference table forms a reference to at least one successor.

Access to the entries in the record table and the reference table is always made with one and the same index. The entries in the two tables may themselves vary substantially in size, however. The size of the entries in the record table depends on the scope of a display image, while the size of the entries in the reference table depends on the index length necessary for the size of the tables. Where there is more than one successor index per entry in the reference table, from which one is always selected by particular signals or states, the memory space of an entry increases accordingly.

In the read mode according to the invention, which may be adopted independently of the chip card terminal, the memory is read out. By actuating the switching means, the information contents of the display images are displayed in succession in the stored sequence predetermined by the ordering relationships. The table index is applied to both tables in an address register, beginning with a start value, as a memory address. The currently addressed entry is thereby read out from the reference table and fed to the drive connections of the display. It is clear that the signals generated thereby are conformed to the display actually present (matrix, 7 segment digits, alphanumeric displays or the like).

If the next display image is to be displayed, the content of the currently addressed entry of the reference table is accepted into the address register. According to a further preferred development of the invention, in the case of a plurality of stored successor indices, the chosen index is selected in the entry. The process of acceptance into the address register proceeds either on an external signal, e.g. by actuating the switching means, or independently after a predeterminable period of time.

It is clear that even with relatively small displays, e.g. chip cards, relatively extensive information contents may thus be displayed in a sequence of display images. Of particular advantage is the restriction of switching activity in read mode to a few active parts of the display drive circuit. The procedures for progressing the sequence of information contents (display images) are limited to reading out individual table entries from the memory, transfers from the reference table into the address register occurring at relatively large intervals and addressing of the memory, on the basis of the current content of the address register.

Thus, simple circuits with a clear structure and low power demand may be produced. Link-up of the drive circuit of the display to a master unit (controller, processor) of the chip card may proceed by serial connection or a serial data bus. In a preferred development of the invention, provision is made for a bus protocol to I²C standard to be provided, with a two-wire connection between master unit and display drive circuit.

By separating the circuit components of the circuit arrangement for write mode and read mode, the internal power source may in particular be limited to the power demand in read mode, since, during write mode, the chip card is coupled to the chip card terminal and may be supplied with the necessary power thereby. Thus, more extensive, complex operations of the display drive circuit may also be triggered by the greater quantity of power supplied in this case when the drive circuit is in write mode. Thus, for example, the modular design of the protocol of the interface between master unit and display drive circuit may be supported at a higher logic level. By suitable software design, the master unit may also organize ordering relationships for the information contents which are more complicated, from the point of view of structure, than a simple continuous sequence. These ordering relationships may be generated and modified in particular in relation to the application and then entered in initializing manner into the reference table.

By the explicit storage of the ordering relationships in the reference table, provided according to the invention, support is provided for rapid operation for the information contents of the individual display images. In this way, an additional time requirement in write mode, as is actually available during communication of the chip card with the chip card terminal, is not necessary. In the case of the explicit fixed ordering relationships, any removal is associated merely with the effort involved in changing the successor reference of the predecessor(s). The successors of the entry in the record table to be removed are entered therein. Reordering of the information contents of the display images which are stored in the record table also relates only to the reference table. Since this is typically substantially smaller in data scope than the record table, simpler and quicker handling is provided.

Insertion of the information contents of display images may likewise proceed very advantageously at any point in the record table, without displacement of the subsequent part of the record table. This means that full reading out and re-storing of the data content of the entire record table is thus dispensed with. To this end, the information content (display image) to be inserted is written to an entry in the record table which is free or is coming free. Actual insertion is effected by a small number of entries in the reference table storing the ordering relationships. Cyclical concatenation of the information contents is also possible in that an entry is referenced as its own direct or indirect successor. This may occur directly by means of writing-in of the current index into the current reference entry. Cyclical concatenation arises indirectly in that a later reference entry in the successor chain is back-referenced to the current entry.

If the record table and reference table are used as a basis for the construction of a dynamic data structure, singly or doubly concatenated lists, trees, cyclical extensions thereof and other organizational forms may preferably be produced. The selected structure with record table and reference table also allows simple data organization, however. To this end, a fixed sequence may preferably be produced in the reference table in a single operation with an initialization routine. Initially, the next entry may preferably be entered in fixed manner as the respective successor. This data organization is performed by the master unit (controller, processor) and may be selected with a wide degree of freedom in accordance with the desired application.

In a further preferred development of the invention, error handling is provided. In this way, interrupted and incomplete data transactions using the chip card terminal may either be displayed and/or labeled for subsequent correction. Arbitrary, accidental interruption of transactions, in particular by premature removal of the chip card from the chip card terminal, may then be taken into account. In this way, it is possible for operations being written in write mode according to the invention into the memory of the drive circuit not to be concluded. A valid flag, which is reset before writing is begun and is set to valid again after conclusion thereof and optionally after testing by reading and comparison of the writing, may prevent unnoticed errors which arise in this way.

In addition, provision is made in a preferred development of the invention for a general error protection or error handling process to be provided for communication between drive circuit and master unit (controller, processor), which is preferably distinguished by low effort. This may relate, for example, to the detection of process synchronization problems caused by external events by means of flagging mechanisms known per se.

The complete conclusion of operations is preferably also ensured by additional blocking times until both sides are reset to valid after the last transmission between master unit (controller, processor) and display drive circuit or chip card terminal. In this way, it is advantageously achieved that the validity of transmission operations may be signaled by flag states. Before a new transaction is begun, the valid conclusion of the last transaction is tested, with a suitable response in the event of invalidity, e.g. at least one attempt at repetition. The error handling which is preferably provided is also determined by the specific application, in particular by whether and to what extent it is to occur.

Thus, in a further preferred development of the invention, provision may be made for error handling by initializing entries in an initial write operation to be dispensed with even when the latter are provided in fixed manner in read mode by the circuit arrangement. Provision may in particular be made for duplicated table entries to be able to by-pass error handling in the event of errors and also for normal functioning.

In a further preferred development of the invention, provision is made for at least one self-exhausting and/or continuously regenerable internal power source to perform read mode. A self-exhausting power source may take the form of a primary battery, for example. A regenerable power source may for example be a solar cell or a piezoelectric crystal. A piezoelectric crystal offers the possibility, in particular, that, by actuating a switching means, e.g. the switching means for activating read mode, generation of the required electrical power may be triggered. A very compact, robust construction of the circuit arrangement is produced thereby. When using chip cards in particular, very advantageous application possibilities are thereby obtained. According to further preferred developments, an accumulator may also be used as regenerable power source, which accumulator may be rapidly charged for example during chip card terminal operation. Finally, in a preferred variant of embodiment, the regenerable power source takes the form of a capacitor, which is in a position to store power charges for an adequate length of time. It goes without saying that, according to further preferred developments of the invention, at least one of the self-exhausting and/or at least one of the regenerable power sources may be combined.

Further preferred developments of the invention are obtained in that at least parts of the circuit arrangement for driving the display are structured in one or more layers of the display or in a switching circuit integrated into the display. The “chip-on-glass” or “chip-on-plastics” production processes known per se may preferably be used therefor. In addition, the drive circuit or at least parts of the drive circuit are preferably integrated into surfaces next to and/or between the display elements. It is additionally feasible to subdivide the circuit arrangement, i.e. to incorporate at least one circuit unit, in particular the circuit components forming the record table and/or reference table, in the vicinity of the display.

In a further preferred development of the invention, provision is made for the circuit arrangement for driving the display to receive a clock supply from the chip card terminal in write mode and for an internal clock supply to be generated in read mode, in particular by an oscillator. It is especially possible to dispense with the internal oscillator for clock supply when read mode is achieved without an inherent clock oscillator, in that external signals, in particular actuation of the switching means, in each case supply a pulse defining the next state. In this way, the circuit arrangement may be produced particularly simply.

The chip cards with display according to the invention may be used for example as electronic purses (cash cards), check and/or credit cards, store cards, discount cards, loyalty cards, telephone cards, health insurance cards, fuel cards, identity cards, top-up cards for mobile telephones or the like. Additional information is made available to the card holders via the display, which, for example, makes the transaction processes performed with the card immediately transparent. Further preferred applications consist for example in transmitting validation of entry cards, travel cards, daily, weekly or monthly season tickets or the like from appropriate automatic machines to a chip card with display according to the invention in a manner comprehensible to the user. Such validation or the implementation of such validation may preferably be associated with an automated payment function, e.g. by debiting a corresponding value in a chip card terminal. In addition to recognition of validation, it may also be made possible to document cancellation or partial cancellation of implemented validation and to make this requirement visible to a user or an authorized inspector of the card with display. In addition, it is preferably possible to provide the chip cards according to the invention with additional information, e.g. seat reservations, time information, public transport connections, transport information, weather information, advertisements or the like. Information displayable on the display may for example be additionally secured by an access security means, which is preferably combined with the chip card. This may be implemented for example by providing a particular input combination or input sequence or a biometric feature. In the case of biometric features, the chip cards according to the invention may also be used for example as legitimation cards (identity card, passport or the like).

Finally, in a further preferred development of the invention, provision is made for the method according to the invention and the circuit arrangement according to the invention for driving a display to be applied in drive circuits for displays in or on mobile devices or systems. Such an application is provided for example in the case of cell phones or wireless landline telephones, in which, in addition to the actual functions thereof, additional functions may be obtained which manage with a low power demand when in read mode. These may comprise telephone book displays, independent displays of SMS messages or the like, for example. Thus, such information could be displayed on the display even when the actual functions of such devices are no longer usable due to a discharged main accumulator.

It is additionally advantageously possible to provide the additional information retrievable in read mode in the periods in which the mobile devices are in a rest state (stand-by state). Thus, activation of the main power supply of the mobile devices would not be necessary for the display of additional information.

Further preferred options for application of the invention include remote operation of electronic devices, e.g. home electronics, especially for displaying operating functions or acknowledgement signals from remote-controllable devices. Further preferred applications include for example pagers, telephones, electronic car keys, goods recording devices, electronic toys or the like. Moreover, one preferred application is in measuring instruments. In these, a measurement, measurement series or the like recorded by the measuring instrument could be read out on the display, even without full functioning of the measuring instrument. Examples of such devices are energy meters, alarm systems, on-board computers, payment terminals, acceleration and radiation protocol devices, dosimeters, chemical instruments, medical instruments or the like.

In conclusion, it should be noted that the method according to the invention and circuit arrangement according to the invention may be used in devices in which information or additional information is to be displayed without activating the actual device function or the main supply thereof, or if the latter is interrupted. From all the above, it is clear that the method according to the invention and the circuit arrangement according to the invention allows a separate display drive, which accepts information contents for one or more display images in write mode and outputs the information contents for one or more display images in read mode. Explicit storage of the ordering relationships of the display images in the reference table of the memory is implemented for the sequence of the display images. Progression of the sequence itself may be achieved by user interaction or independently under time-control. Control of said progression uses the entered ordering relationships in the reference table, to determine the respective next display image. The circuit required for read mode makes direct use of the entries in the reference table of the memory. It is therefore simply structured and constructed in power-saving manner. Short data transfer times may be achieved in write mode by a suitable organizational form for the ordering relationships to be explicitly fixed.

Further preferred developments of the invention are revealed by the remaining features mentioned in the subclaims.

The invention will be further described with reference to examples of embodiments shown in the drawings, to which, however, the invention is not restricted:

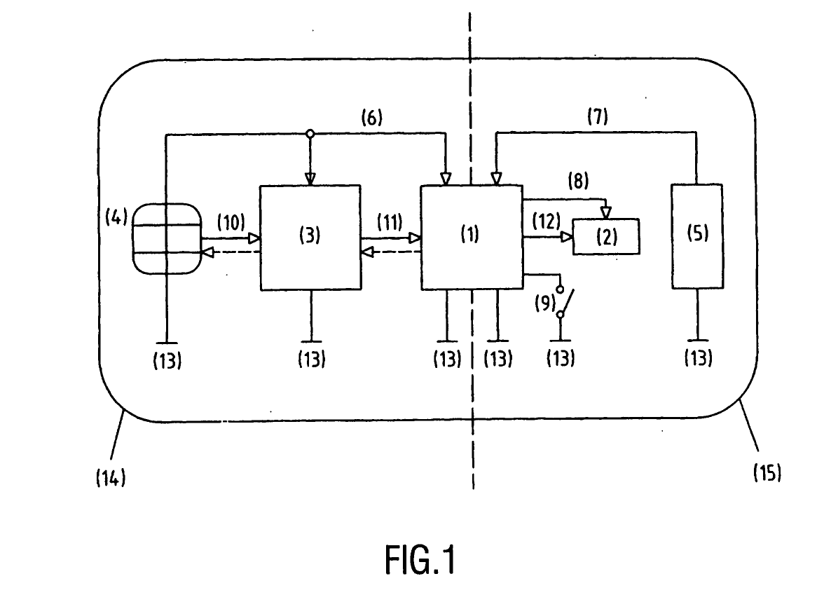

FIG. 1 is a survey diagram of a typical chip card with display and contacts;

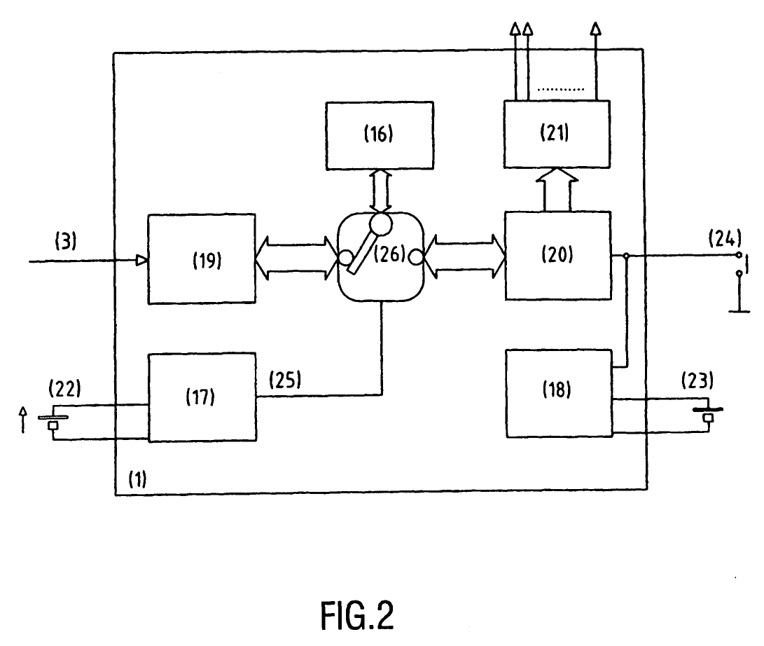

FIG. 2 is a block diagram of the display drive circuit in write mode;

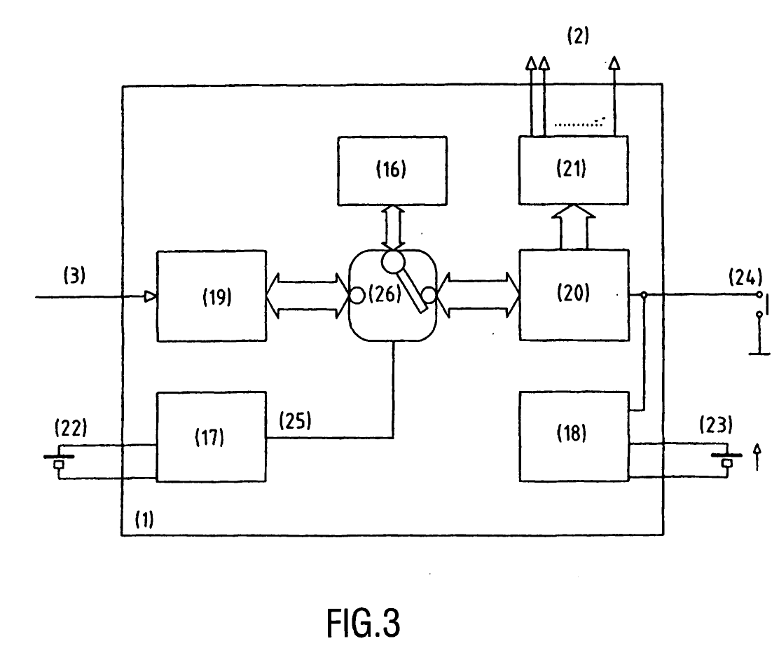

FIG. 3 is a block diagram of the display drive circuit in read mode;

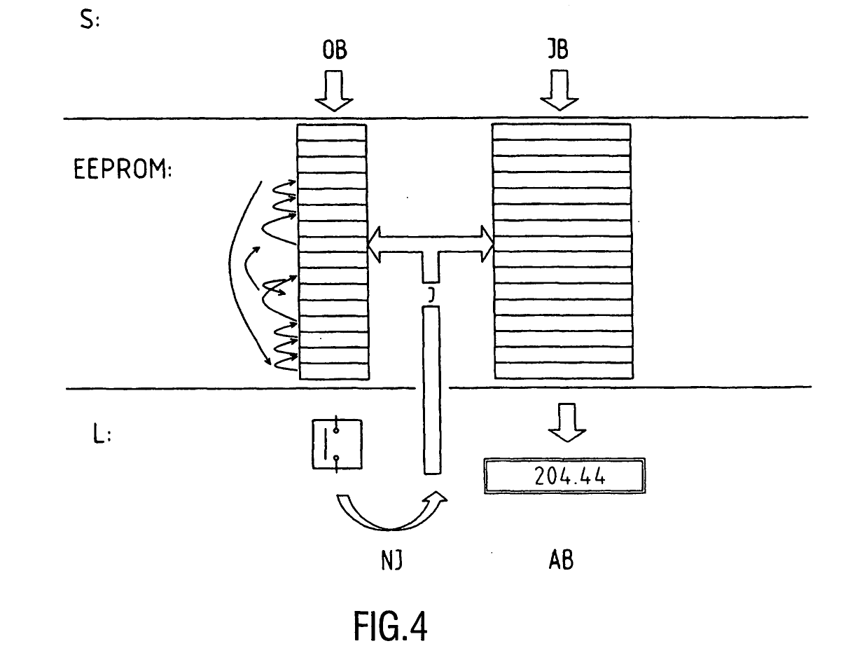

FIG. 4 is a schematic representation of the operating mode procedures and memory organization;

FIG. 5 shows the procedure for deleting a display image from a sequence;

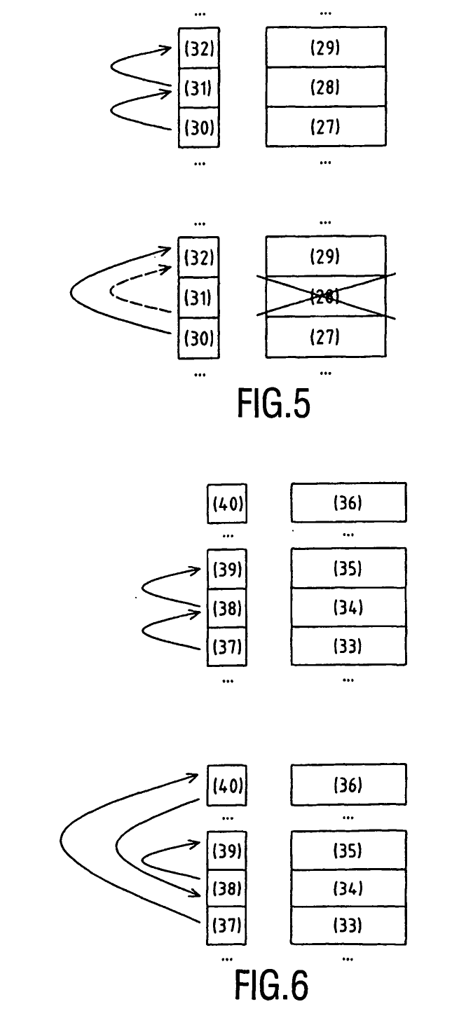

FIG. 6 shows the procedure for inserting display images into a simple reference list;

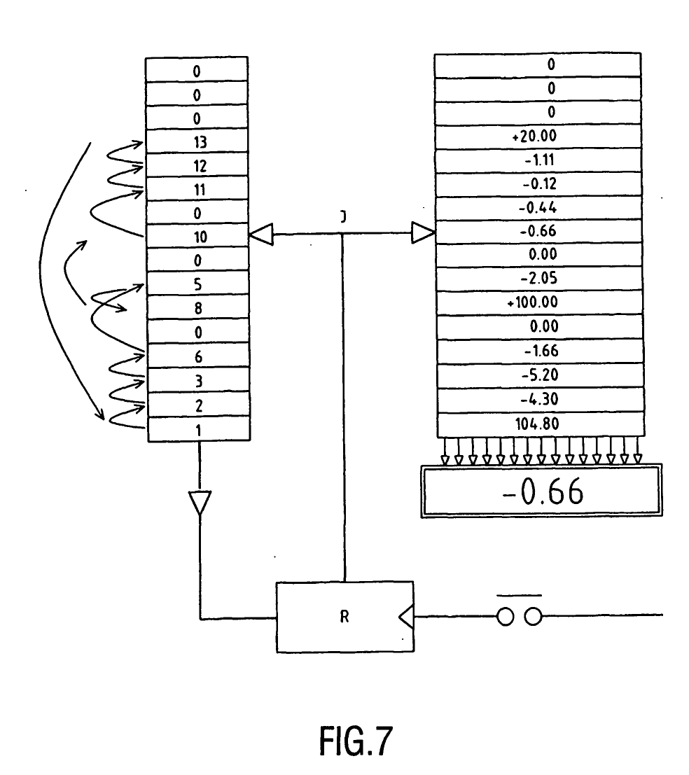

FIG. 7 shows an example of the data structure in the case of a purse chip card with display,

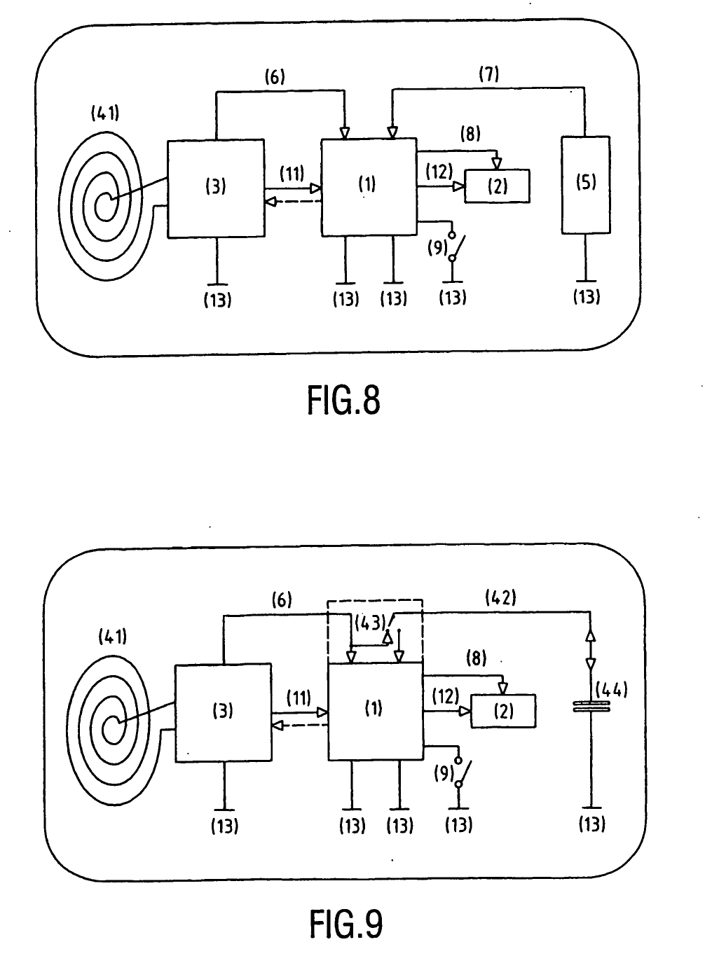

FIG. 8 shows a drive application in a contact-less chip card and

FIG. 9 shows a drive application in a contact-less chip card and charging of the internal power source.

FIG. 1 shows the survey diagram of a typical chip card with display and contacts. A display drive circuit 1 is shown in central position. To the right thereof is a display 2 and to the left a chip card controller 3 and a contact field 4. At the right-hand edge an internal power source 5 is shown symbolically, this taking the form, for example, of a battery, an accumulator or a solar cell. From the contact field 4 there extend lines 6 for the operating voltage and clock supply to the chip card controller 3 and the display drive circuit 1.

The internal operating voltage is conveyed via a connection 7 from the power source 5 to the drive circuit 1 and optionally thence via a line 8 to the display 2, while being adapted to the display technology.

A momentary contact switch 9 (switching means, e.g. a snap-action disk or flat switch) is connected to the drive circuit 1.

The information from the chip card terminal is transmitted from the contact field 4 to the controller 3 via data lines 10; serial transmission formats are typically used. Likewise, in numerous applications, data flows thereover in the opposite direction. Information from the chip card controller 3 to the drive circuit 1 is entered only in write mode, this being effected via a data connection 11 which is used, for example, for serial transmission or with a bus protocol. Only reading of status information or read-out operations (e.g. for control purposes) proceed exceptionally in the opposite data direction. The segments of the display are operated from the display drive circuit 1 via control terminals 12. All the components exhibit a common ground connection 13.

The circuit part 14 extending in the drawing from the left to the middle is active in write mode, while the right-hand circuit part 15 is active in read mode. Only the drive circuit 1 operates in both modes. This is shown in more detail in the subsequent drawings.

FIGS. 2 and 3 show the block diagram of the display drive circuit 1. The situation in the drawings symbolizes subdivision into components only for write mode (left) and only for read mode (right). In the middle, components are illustrated which are used in both modes.

The operating voltages are supplied by conditioning circuits 17 or 18, of which there is one each for the terminal supply voltage 22 or an internal source 23.

The terminal supply voltage 22 is used in write mode and then supplies a non-volatile EEPROM memory 16 and a write mode control circuit 19. This accepts data from the controller and forwards it via switching logic 26 (here illustrated schematically as a switch) to the EEPROM 16. However, it also allows individual read operations, for instance for monitoring purposes or in order to accept entered error states for error handling. The switching logic is actuated by the terminal supply voltage 22 via a control signal 25, such that write mode is constantly active when the terminal supply voltage 22 is applied. Read mode can only be adopted when no terminal supply voltage 22 is applied.

On the right-hand side, a control circuit 20 for read mode and a driver circuit 21 for the display lines are shown, which drive the display segments. These are supplied in read mode by the internal power source 23 via the conditioning circuit 18.

This circuit block may additionally assume control of the adoption of sleep mode with minimal power consumption and of waking therefrom. In sleep mode, the circuit blocks hitherto supplied in read mode are switched off.

To be woken from sleep mode into read mode, the circuit is connected with a switching means (momentary contact switch) 24. If the momentary contact switch 24 is not actuated for a predeterminable time in read mode, sleep mode is resumed.

FIG. 3 is a schematic representation of switchover of the switching logic 26 into read mode. Here, the EEPROM memory 16 is switched over from the write mode control circuit 19 to the read mode control circuit 20. The circuit blocks otherwise correspond to those of FIG. 2.

FIG. 4 is a schematic representation of the operating mode procedures and memory organization. It is shown therein that the ordering relationships and the contents are entered in write mode. The EEPROM memory 16 of the display drive circuit 1 is divided into a table of references (left, hereinafter also designated reference table) and a table for the display images (right, hereinafter also designated record table). In read mode, references are read out and used as a new index after a key stroke and additionally the currently indexed display image is forwarded to the display. In FIG. 4, the following abbreviations are used: S=write mode. L=read mode, OB=image ordering, IB=image information, AB=current image, I=index and NJ=next index.

FIG. 5 shows the procedure for deleting one of the display images, which are organized in each case with regard to the immediate successor in relation to their sequence in a simple reference list. Clear therefrom is the small amount of effort involved, merely one write operation being required in the reference list. No gap arises in the reference list—it may continue to be read out along the ordering relationships (reference to the next element) by the read mode circuit without special treatment of deleted entries.

The upper part of FIG. 5 shows the state prior to deletion and the lower part shows the state after deletion for a portion of the record table. First of all, three display images 27, 28 and 29 are shown with the associated references 30, 31 and 32. They are concatenated in such a way that the image 27 is followed by the image 28 and the latter in sequence by the image 29. The arrows symbolize the concatenation.

If, by way of example, it is then desired to remove the middle display image 28 from the three images, the reference 30 is overwritten in such a way that the index of the reference 32, which matches the display image 29, is entered at that point.

Consequently, the display image 28 to be deleted no longer appears in the sequence.

Clearly, the advantage from the point of view of time saving is obtained by the explicit storage of the ordering relationships, said advantage being obtained by the storage space for the references.

This example easily clarifies the advantages of the explicit ordering according to the invention over conventionally obvious implicit ordering.

In the case of implicit ordering, i.e. in the case of consecutive storage without references, all the images after the one to be deleted would have to be displaced. For the task given in the example, it would then be necessary to read and write at least the image 29 and any that may follow, wherein each image typically comprises considerably more data than a reference. Thus, during the period in which the chip card is in use in or at the terminal, substantially more data would have to be moved between chip card controller and drive circuit, which would have the consequence in particular of prolonging the transactions to an undesirable degree.

FIG. 6 shows the procedure for inserting a display image, the sequence being organized in a simple reference list.

The upper part of the drawing shows a portion of the record tables with entries for three display images 33, 34 and 35. Furthermore, the references 37, 38 and 39 are so concatenated that image 34 follows display image 33, and is in turn followed by image 35. The arrows symbolize the concatenation.

A free entry 36/40 is also shown in one of the tables. The state prior to insertion is thus illustrated.

A new image is to be inserted after display image 33. To this end, the content of the display image to be inserted is entered in the entry 36 in the record table. The reference 37 is then changed to the index of the entry 40/36. Moreover, the corresponding index for the successor 38/34 is written in the reference 40.

The lower part of the drawing then shows the state after insertion.

Altogether, it is clear that no complex re-storing is necessary when the explicit ordering relationships are organized in the form of a concatenated reference list.

As with the example in FIG. 5, a comparison with conventionally obvious implicit ordering shows the massive advantage. Finally, with this insertion operation too, the chip card transaction in or at the terminal does not have to be prolonged substantially.

FIG. 7 shows an example of a data structure for an electronic purse or a payment receipt on a chip card. The display images shown to the right contain as first entry the debited amount (here 104.80 value units). There then follow the last transactions (most recent −4.30 value units, preceded by −5.20 value units, then in order by −1.66, −2.05, +100.00, −0.66, −0.12, −1.11 and +20.00 value units). The entries 0.00 and −0.44 value units are not accessed, they may have been deleted earlier, for example. The indices begin with the index 0. Each entry in the table has precisely one index. In this case, the index entries 0, 1, 2, 3 . . . etc are designed to run from bottom to top.

The index 0 is also generated in the index register when read mode is switched on. This index 0 is also intended to relate to the initial entry in the reference table, which is also used as a reference after wake-up from sleep mode.

The reference table contains a simple sequence list (indices 1, 2, 3, 6, 5, 8, 10, 11, 12, 13, 0). The entry at index 14 refers to the index 0, thereby closing the cycle. This example shows that the implicit index sequence may be complied with in referencing by corresponding explicit entries (e.g . . . 1, 2, 3, . . . or . . . 11, 12, 13, . . . ), but in other cases does not have to be taken into account (e.g. . . . 6, 5, 8, 10, 12, . . . or . . . 13, 0, . . . ). A flexible, optional organization option is provided by suitable entries in the ordering relationship reference table. The bottom part shows the common index register for both tables, progression being shown symbolically by a pulsed clock signal.

FIG. 8 shows application of the drive circuit according to the invention in a contact-less chip card. The contact field is replaced here by the antenna 41 with receive circuit. It supplies power, clock and information. For low and moderate frequencies, the antenna often takes the form of a coil. For higher frequencies, other structural forms are used, e.g. dipole or planar array antennas. Contact-less coupling to a terminal may also be achieved capacitively. The other components and connections shown in the Figure correspond to those of FIG. 1.

FIG. 9 shows a drive application in a contact-less chip card and charging of the internal power source.

As in FIG. 8, an antenna 41 produces the connection to the terminal. The voltage for write mode, which was obtained from the antenna, simultaneously charges a regenerable internal power source 44. To this end, the connecting line 42 between the drive circuit 1 and the power source 44 is used for the charging current and for the discharging current in read/display mode.

The drive circuit 1 has been extended by a changeover switch 43. By way of example, a capacitor is shown as a regenerable source 44, but accumulators are also possible. The other components and connections shown and indexed in FIG. 9 correspond to those in FIG. 1.

### LIST OF REFERENCE NUMERALS

1 Drive circuit
2 Display
3 Chip card controller
4 Contact field
5 Power source
6 Line
7 Connection
8 Line
9 Momentary contact switch
10 Data line
11 Data connection
12 Control terminals
13 Ground connection
14 Circuit part
15 Circuit part
16 EEPROM memory
17 Conditioning circuit
18 Conditioning circuit
19 Write mode control circuit
20 Read mode control circuit
21 Driver circuit
22 Chip card terminal supply voltage
23 Internal power source
24 Switching means (momentary contact switch)
25 Control signal
26 Switching logic
27 Display image
28 Display image
29 Display image
30 Reference
31 Reference
32 Reference
33 Display image
34 Display image
35 Display image
36 Table
37 Reference
38 Reference
39 Reference
40 Table
41 Antenna
42 Connecting line
43 Changeover switch
44 Power source
S Write mode
L Read mode
OB Image ordering
IB Image information
AB Current image
I Index
NJ Next index

1. A method of driving a display, in particular a display on a chip card, having the steps:
(a) in write mode, information to be displayed on the display which comprises at least one item of information content (display image) to be presented on the display is stored in a drive circuit associated solely with the display;
(b) also in write mode, selectable ordering relationships are stored which are assigned explicitly to each of the items of information content and which determine the sequence of information contents in the event of display;
(c) in read mode, the information to be displayed and comprising at least one item of information content is called up from the drive circuit and displayed on the display, wherein
(d) the stored and explicitly assigned ordering relationships are taken into account with regard to the call and thus the display sequence.

2. A method as claimed in claim 1, characterized in that
(a) the read mode is adopted by means of an external wake-up signal from a rest state (sleep mode), without activity apart from retaining the ability to respond to wake-up signals;
(b) then, as the first of the display images, a display image determined by the predeterminable ordering relationship is displayed, wherein this ordering relationship was stored at a fixed initial entry, which is evaluated as a result of the wake-up signal.

3. A method as claimed in claim 2, characterized in that read mode is terminated after the expiry of a predeterminable period, for transfer back into the rest state (sleep mode).

4. A method as claimed in claim 2, characterized in that the external wake-up signal is generated by manual actuation of a momentary contact switch.

5. A method as claimed in one of the preceding claims, characterized in that
(a) the data of the display images are stored in a record table, in which each entry corresponds to an image;
(b) the data of the ordering relationships for displaying the display images are stored in a reference table, wherein each entry corresponds to the table index of the next display image to be displayed and of the next entry/ies in this ordering relationship table.

6. A method as claimed in claim 5, characterized in that
(a) the next one of the display images is displayed after manual actuation of a momentary contact switch,
(b) wherein the index of the next table entry to be displayed of the display images is read out from the current entry in the ordering relationship reference table and
(c) this index points at the same time to the next entry in the ordering relationship reference table.

7. A method as claimed in claim 6, characterized in that
(a) each entry in the ordering relationship reference table is divided into a plurality of portions, each of which contains a successor index;
(b) each of these portions of the table entries is read out individually as desired, if an associated momentary contact switch has been actuated;
(c) a display image selected as the next is displayed after actuation of one of a plurality of momentary contact switches,
(d) wherein the index of the next table entry to be displayed of the display images is read out from a portion (associated with the actuated momentary contact switch) of the current entry in the ordering relationship reference table and
(e) this index points at the same time to the next entry in the ordering relationship reference table.

8. A method as claimed in one of claims 5, characterized in that a signal replaces actuation of the momentary contact switch(es), which signal is generated automatically after a predeterminable period.

9. A method as claimed in one of claims 5, characterized in that referencing via the indices, which are stored in the ordering relationship reference table, produces concatenation of all valid display images, wherein each reference refers to at least one of the successors, such that an at least singly concatenated list is formed.

10. A method as claimed in claim 9, characterized in that concatenation produces at least a cyclical sequence of the displayed display images.

11. A method as claimed in one of claim 7, characterized in that the adoption of an error state is represented by the display of a particular display image from a reserved table entry, wherein the index for accessing this table entry by the process of error detection is generated by the write mode control circuit.

12. A method as claimed in one of claims 7, characterized in that
(a) the continued existence of an error state after renewed determination of the display sequence is represented by the display of a special display image from a reserved table entry, wherein the index for accessing this table entry by the process of error detection is generated by the read mode control circuit, and
(b) is entered in the ordering relationship table as an initial index.

13. A circuit arrangement for driving a display, in particular a display on a chip card, characterized by a drive circuit associated solely with the display, which may be switched into write mode and read mode, wherein the drive circuits may be activated for read mode independently of a control circuit activating write mode and providing information contents to be displayed, the drive circuit comprises a non-volatile memory, wherein a first circuit unit is provided which serves in separate entry of information to be displayed, which information comprises at least one item of information content (display image) to be presented on the display, in that information contents corresponding to the information to be displayed and organization relationships assigned thereto may be stored separately, and a second circuit unit is provided which serves in reading out the information to be displayed and the assigned organization relationships, wherein the second circuit unit may be activated via a switching means.

14. A circuit arrangement as claimed in claim 13, characterized in that the drive circuit is arranged spatially separately from the master circuit supplying the information to the displayed.

15. A circuit arrangement as claimed in one of claim 13, characterized in that the drive circuit is arranged spatially within the display component.

16. A circuit arrangement as claimed in claim 15, characterized in that the drive circuit is arranged as the first in a series of series-connected circuit components of the display component downstream of the interface with the chip card controller.

17. A circuit arrangement as claimed in claim 13 characterized in that the drive circuit is supplied in each operating mode (write mode, read mode) from its own, separate power source.

18. A circuit arrangement as claimed in claim 17, characterized in that the power source for read mode is an electrochemical power source (primary battery/accumulator) and/or a long-life capacitor and/or a solar cell/solar panel and/or a piezoelectric crystal element, which supplies electrical power as a result of manual exertion of pressure, and/or a thermoelectric cell (peltier element), which supplies electrical power as a result of temperature differences due to hand contact.

19. A circuit arrangement as claimed in claim 18, characterized in that
(a) after a use-determined interruption of the power source (blocking of light/termination of pressure or heat supply) in read mode, the rest state is adopted and then read mode automatically resumes when this interruption stops;
(b) upon resumption, the sequence of display images starts again, starting from a fixed initial entry or the non-volatilely buffered state directly before the use-determined interruption;
(c) wherein the explicitly stored ordering relationships of this initial entry or this state are read out to determine the first display image to be displayed after resumption.

20. A circuit arrangement as claimed in claim 17, characterized in that the power source for write mode is provided by a chip card terminal, which supplies the operating voltage via contacts.

21. A circuit arrangement as claimed in claim 17, characterized in that the power source for write mode is provided by a chip card terminal, which introduces electrical power into the circuit in contactless manner via electromagnetic AC fields.

22. A circuit arrangement as claimed in one of claim 13, characterized in that the control circuit clock pulse signal for write mode is provided by a chip card terminal.

23. A circuit arrangement as claimed in one of claims 13, characterized in that the control circuit clock pulse signal for read mode is generated autonomously in the mobile chip card apparatus.

24. A circuit arrangement as claimed in one of claims 13, characterized in that the progression signal for changing the display image to be displayed is supplied from a source which is external relative to the drive circuit.

25. A circuit arrangement as claimed in claim 24, characterized in that the progression signal is generated by momentary contact switch actuation.

26. A circuit arrangement as claimed in claim 24, characterized in that the progression signal is generated automatically by a time-determined circuit part after a predeterminable time.

27. A circuit arrangement as claimed in one of claims 13, characterized in that
(a) there exists a data connection to the display drive circuit from the master circuit, which supplies the information to be displayed, and
(b) this data connection serves in serial transmission in write mode of the information to be stored.

28. A circuit arrangement as claimed in one of claim 13, characterized in that
(a) there exists a data connection to the display drive circuit from the master circuits, which supplies the information to be displayed, and
(b) this data connection has a bus protocol for transmission in write mode of the information to be stored.

29. A circuit arrangement as claimed in one of claim 13, characterized in that electrically erasable programmable read-only memory cells (EEPROM) also store the data of the display images and the image ordering relationships in non-volatile manner when the drive circuit is in neither write mode nor read mode.

30. A circuit arrangement as claimed in claim 28, characterized in that low power consumption volatile memory cells replace the non-volatile memory cells of the stated claim and these are supplied continuously by the read mode power source.

31. A chip card, characterized by a circuit arrangement as claimed in claim 13.
